(19) United States
(12) Patent Application Publication
(10) Pub. No.: US 2025/0168733 A1
(43) Pub. Date: May 22, 2025

(54) Dynamically Configuring Wi-Fi Coverage in a Neighborhood

(71) Applicant: Adeia Guides Inc., San Jose, CA (US)

(72) Inventors: Dhananjay Lal, Englewood, CO (US); Jean-Yves Couleaud, Mission Viejo, CA (US); Christopher Phillips, Hartwell, GA (US)

(21) Appl. No.: 18/510,817

(22) Filed: Nov. 16, 2023

(51) Int. Cl. H04W 36/30; H04W 36/08; H04W 84/12

(52) U.S. Cl. CPC H04W 36/304; H04W 36/08; H04W 84/12

(57) ABSTRACT

Systems and methods for managing coverage in a high-density wireless environment are disclosed. A client device detects low signal strength from its assigned router. The signal strength of a neighboring router is determined to be higher than that of the assigned router. Based on the determination, the neighboring router is configured with a customer-specific SSID of the client device. The client device uses its customer-specific SSID to connect with the neighboring router. Upon determining that the neighboring router has available bandwidth to support a bandwidth request of the client device, the bandwidth is provisioned to the client device from the neighboring router. Routers with low signal strengths may be selectively disabled and collect signal strength data of neighboring routers. Active routers maybe configured with the respective customer-specific SSIDs of the disabled routers. A switch is installed at the front-end of all routers maintains LAN traffic within the LAN boundaries.

### FIELD OF DISCLOSURE

Embodiments of the present disclosure relate to management of Wi-Fi coverage in high-density wireless environments.

### SUMMARY

Managing wireless coverage in high-density wireless environments (such as in multi-dwelling units (MDUs), closely spaced single-family units (SFUs), or business buildings) can be challenging, as many neighboring access points are densely located the number of accessible wireless channels is limited. Signal interference occurs in such environments, due to an increased risk of channel overlap or use of adjacent channels by the access points. Customers in such environments may experience poor or inconsistent wireless signal or QoS with their internet service provider (ISP). Therefore, improved techniques for managing wireless coverage in high-density wireless environments are desired.

In one approach, a customer experiencing poor signal and bandwidth from their assigned router may ask to use a neighbor's wireless credentials to log into the neighbor's router with better signal. However, customers may often feel more secure with using their own private SSID (Service Set Identifier) when using the internet.

In one approach, customers may configure and manage their own router (e.g., manually select a Wi-Fi channel which avoids interference with neighboring routers) independently of an ISP. However, customers may prefer zero-touch management (e.g., allowing the ISP to manage wireless coverage and configuration).

Moreover, such approaches offer little to no security measures for ensuring LAN privacy, such that, for example, the LAN traffic does not traverse to the edge of the LAN boundary and to the ISP.

In an embodiment, a client device associated with a router (e.g., assigned router) and a customer-specific SSID (e.g., originated by the assigned router) in a high-density wireless environment detects low signal strength from its assigned router. The customer-specific SSID may be a private SSID which is only visible to the client device. The client device may perform a speed test to validate that the assigned router has a low throughput. The client device may collect signal strength data of neighboring router(s). The client device may compile an evidentiary report including its location, its customer-specific SSID, signal strength data and the BSSID (Basic Service Set Identifier) of its assigned router or access point, and signal strength data and BSSID(s) of the neighboring router(s). The evidentiary report may be sent to a network connection manager, which manages wireless coverage of an ISP of the client device. The network connection manager determines that the signal strength of a neighboring router is stronger than that of the assigned router. In addition, or alternatively, the network connection manager detects that a performance metric of a wireless network connection with a neighboring router is better than a performance metric of the wireless network connection with the assigned router (e.g., the connection with the neighboring router is more stable, has higher bandwidth, has lower latency, and so forth). The network connection manager also determines that the neighboring router has enough available bandwidth (or other quality of service (QoS) parameter(s), such as low packet loss, low jitter, low latency, low retry rate) to serve the client device, without compromising bandwidth (or other QoS) served to other client devices of the neighboring router. For instance, such other client devices of the neighboring router may expect particular QoS as established by their service-level agreement (SLA) with the ISP. Based on the determinations, the network connection manager configures the neighboring router with the customer-specific SSID of the client device, allowing the client device to use its customer-specific SSID to connect with the neighboring router. Once connected, the client device may request bandwidth from the neighboring router. If the neighboring router has enough available bandwidth to support the bandwidth request, the network connection manager configures the connection to provision the bandwidth. For example, the DOCSIS PacketCable Multimedia (PCMM) protocol may be used to configure provisioning of the bandwidth.

In an embodiment, routers in the environment which have low signal strength, such as the assigned router, are selectively disabled, reducing the number of channels in use within an area. The remaining active neighboring routers may be configured with the customer-specific SSIDs associated with the disabled routers and serve the client devices of those customer-specific SSIDs using a single channel. In an embodiment, the disabled routers may serve as monitoring client devices which periodically collect signal strength data of their neighboring routers. The network connection manager may use the signal strength data to dynamically update the coverage map of the high-density wireless environment by selectively disabling routers whose signal strength falls below a threshold and activating routers whose signal strengths return above a threshold.

In an embodiment, a switch is installed at the front-end of the routers in the high-density wireless environment. LAN traffic is directed among the routers such that it does not traverse the switch and exit the boundaries of the LAN.

A benefit of the described methods and systems includes providing the customer with consistent QoS with their wireless internet connection in a high-density wireless environment, without compromising the QoS of neighboring users.

Another benefit includes allowing customers to enjoy both a sense of network security and the benefits of zero-touch Wi-Fi management by being able to continue using their customer-specific (private) SSID regardless of which neighboring router their client device is connected to.

Yet another benefit includes optimizing the efficiency of the wireless network of the high-density wireless environment, as the number of active channels is reduced, thereby reducing the risk of signal interference, and increasing ability to support consistent and high QoS.

Yet another benefit includes maintaining LAN traffic within the LAN boundary regardless of which router is serving the client device, thereby ensuring LAN privacy for customers in the high-density wireless environment network. A further benefit includes ensuring LAN privacy for direct to internet connections.

### BRIEF DESCRIPTION OF THE FIGURES

The present disclosure, in accordance with one or more various embodiments, is described in detail with reference to the following Figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative scenario using a system of dynamically configuring Wi-Fi coverage in a high-density wireless environment, in accordance with various embodiments of this disclosure;

FIG. 2 shows an illustrative environment in which a system of dynamically configuring Wi-Fi coverage in a high-density wireless environment is implemented, in accordance with various embodiments of this disclosure;

FIG. 3 shows an illustrative map of channel configuration and Wi-Fi coverage using a system of dynamically configuring Wi-Fi coverage in a high-density wireless environment, in accordance with various embodiments of the disclosure;

FIG. 4A shows an illustrative diagram of internet traffic of devices serviced by a neighboring router, in accordance with various embodiments of the disclosure;

FIG. 4B shows an illustrative architecture of managing internet traffic in a high-density wireless environment, in accordance with various embodiments of the disclosure;

FIG. 5 shows an illustrative block diagram of a network device, in accordance with various embodiments of the disclosure;

FIG. 6 shows an illustrative block diagram of a user equipment (UE) device, in accordance with various embodiments of the disclosure;

FIG. 7 shows an illustrative system sequence diagram of a process of dynamically configuring Wi-Fi coverage in a high-density wireless environment, in accordance with various embodiments of the disclosure; and

FIG. 8 shows an illustrative flowchart of a process of dynamically configuring Wi-Fi coverage in a high-density wireless environment, in accordance with various embodiments of the disclosure.

### DETAILED DESCRIPTION

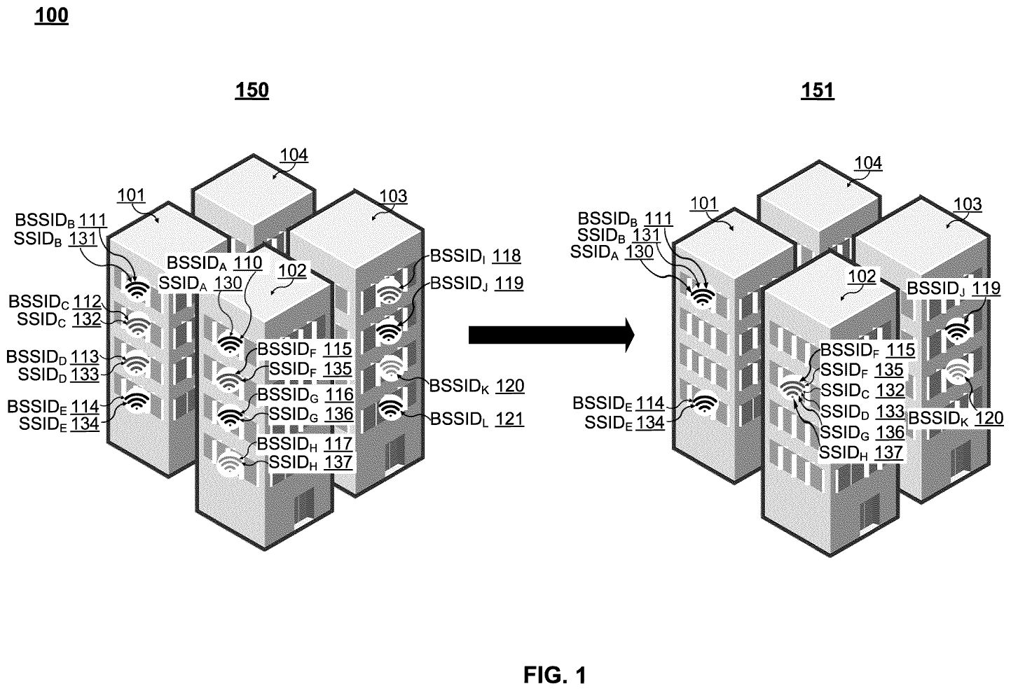

FIG. 1 shows an illustrative scenario 100 using a system of dynamically configuring Wi-Fi coverage in a high-density wireless environment, in accordance with various embodiments of this disclosure. In an embodiment, step 150 comprises a high-density Wi-Fi environment having a plurality of access points located within a certain distance of each other. For example, a high-density Wi-Fi environment can occur in a multi-dwelling unit (MDU) (e.g., comprising buildings 101, 102, 103, 104 in close proximity of each other), closely spaced single family units (SFUs), businesses, etc. Each access point is identified by their respective BSSID (e.g., BSSIDs 110, 111, 112, 113, 114, 115, 116, 117, 118, 119, 120, and 121). Access points can be a router, modem/router, gateway, etc. A user (e.g., internet subscriber) and their client devices may be associated with (e.g., assigned by the internet service provider) an access point and a private SSID. Client devices may include wireless computing devices such as smartphones, tablets, personal computers, laptop computers, smart televisions, or any other suitable device with wireless capabilities. The ISP provisions network resources (such as bandwidth) to the client device(s) of the user via the access point, under the SSID of the user.

For example, as part of their internet subscription, user (A) (not shown) may be assigned a router (e.g., BSSID_{A} 110). The router BSSID_{A} 110 is configured to serve client devices of user A using an exclusive SSID (e.g., SSID_{A} 130) associated with user (A). SSID_{A} 130 is originated by router BSSID_{A} 110 and may be personally configured by user (A) or may be assigned automatically by the internet service provider. Likewise, user (B) (not shown) may live nearby user (A) and may be assigned a router (e.g., BSSID_{B} 111). Router BSSID_{B} 111 is configured to serve client devices of user B using their exclusive SSID (e.g., SSID_{B} 131) associated with user (B). SSID_{B} 131 is originated by router BSSID_{B} 111 and may be personally configured by user (B) or may be assigned automatically by the internet service provider. Other routers (BSSIDs 112, 113, 114, 115, 116, 117, 118, 119, 120, and 121) may each be associated with a respective user and respective customer-specific SSID.

However, when there are many active routers within a certain distance of each other (e.g., when there are many active neighboring routers within a certain area), interference issues may arise. For example, there may be channel overlap or use of adjacent channels between neighboring routers. The risk of interference is aggravated by the limited number of channels available in the Wi-Fi domain. For instance, router BSSID_{A} 110 and router BSSID_{B} 111 are neighboring routers. Router BSSID_{B} 111 may be using a channel which overlaps with or is adjacent to a channel used by router BSSID_{A} 110, resulting in interference of wireless signals from the routers. Such interference can lead to weak RF signal strength from the routers, resulting in the respective users of each router to experience poor signal and throughput. Also, such high channel occupancy in high-density wireless environments can result in increased packet retransmission, resulting in reduced throughput.

Additionally, or alternatively, a router may have low transmit power and/or the client devices connected to the router are too remotely located from the router, resulting in poor RF signal strength in certain areas. For instance, suppose router BSSID_{A} 110 is located in a lower level of user (A)'s home. User A may experience poor signal and throughput when using his connected devices in the upper level of his home. Meanwhile, neighboring router BSSID_{B} 111 may be located closer to user (A)'s devices than router BSSID_{A} 110 is and/or may have higher transmit power than that of router BSSID_{A} 110. According to embodiments disclosed herein, router BSSID_{B} 111 is configured with multiple SSIDs (e.g., SSID_{A} 130 and SSID_{B} 131), such that user (A)'s devices which are located on the upper level may preferentially and automatically connect with neighboring router BSSID_{B} 111. Meanwhile, neighboring router BSSID_{B} 111 continues to service its user (B)'s client devices (e.g., using SSID_{B} 131), and if it has sufficient available bandwidth, neighboring router BSSID_{B} 111 can simultaneously service user (A)'s devices that are located on the upper level (e.g., using SSID_{A} 130). Meanwhile, assigned router BSSID_{A} 110 continues to serve user (A)'s other devices which are located in the lower level (e.g., also using SSID_{A} 130). In another embodiment, router BSSID_{B} 111 is configurable with multiple BSSIDs, at least one of which is configured to service user (B)'s client devices, and at least another one of which is idle. The idle BSSID may be configured to service user (A)'s client devices located on the upper level (e.g., using SSID_{A} 130). In an embodiment, step 151 shows a plurality of (active) routers configured to serve additional client devices using SSIDs originally associated with (e.g., belonging to) neighboring routers, while servicing and without compromising the QoS provisioned to the client devices using the SSID associated with such (active) router. In addition, or alternatively, step 151 shows another plurality of neighboring routers which are selectively and dynamically disabled. In addition, or alternatively, internet traffic between client devices connected to neighboring routers is managed such that it is contained within a VLAN, to ensure internet privacy of the client devices.

In the example, router BSSID_{B} 111 (e.g., belonging to user (B)) is configured with the customer-specific SSID (e.g., SSID_{A} 130) of user (A), while serving and without compromising the QoS provisioned to client devices associated with user B (e.g., client devices using SSID_{B} 131). For instance, a client device associated with user (A) may detect low RF signal strength from its assigned router BSSID_{A} 110. Additionally, or alternatively, the client device can detect that other performance metric(s) of its assigned router BSSID_{A} 110 is undesirable (e.g., compared to a predetermined threshold and/or the performance metrics of neighboring routers), such as lower bandwidth or connection speed, higher drop packet rate, higher retry rate, higher latency, higher jitter, less network stability, etc. In an embodiment, the predetermined threshold comprises one or a combination of desirable QoS parameters. In some embodiments, the client device may detect that based on the performance metric, assigned router BSSID_{A} 110 is unable to support an application operating on the client device which has changing QoS demands (e.g., a streaming video application requiring lower latency or higher bandwidth). Meanwhile, the performance metric of neighboring routers (e.g., routers which are visible or detectable by the client device, such as neighboring router BSSID_{B} 111) may indicate that such neighboring routers are better (e.g., more stable, lower latency, less noisy, etc.) than the assigned router and can support the QoS demands of the application of the client device.

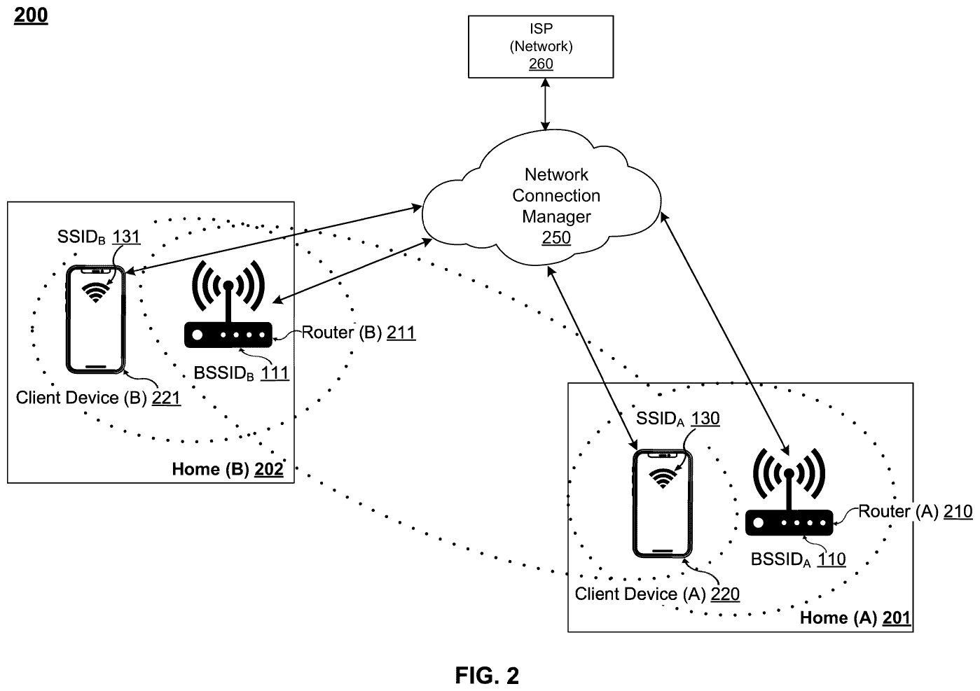

In an embodiment, the client device compiles an evidentiary report, which may include any one or a combination of: the customer-specific SSID (e.g., as stored in a wireless profile of the client device); BSSID of the assigned router; signal strength and/or speed test results of the assigned router; BSSID of neighboring router(s); signal strength of neighboring router(s); other data relating to the signal strength or QoS available of the assigned router and/or neighboring router(s) with respect to the client device's location (e.g., location information of the client device, available bandwidth and/or bandwidth usage from each router), QoS required by an application associated with the client device, and so forth. The neighboring routers may be those routers which are visible (e.g., detectable or accessible) by the client device. In some embodiments, the neighboring router and the assigned router are the same. Based on the evidentiary report, a network connection manager (e.g., network connection manager 250 of FIG. 2) may determine that a neighboring router such as router BSSID_{B} 111 is better equipped to serve a client device of user (A). For example, router BSSID_{B} 111 may have stronger signal strength at the location of the client device of user (A) than that of router BSSID_{A} 110.

Based on the determination, the network connection manager configures router BSSID_{B} 111 with the customer-specific SSID of user (A)'s client device (e.g., SSID_{A} 130). This allows user (A)'s client device to connect with its neighboring router BSSID_{B} 111 using its exclusive SSID_{A} 130.

In some embodiments, router BSSID_{B} 111 is configurable with multiple BSSIDs, wherein a BSSID is configured to service client devices of its associated user (e.g. by way of the user's customer-specific SSID), and a second BSSID is configured to service client devices of a neighboring user (e.g., by way of the neighboring user's customer-specific SSID). For example, the neighboring router may be configured with BSSID_{B} 111 and a second BSSID (e.g., BSSID_{B2}, not shown). BSSID_{B} 111 may be configured to service user (B)'s client devices using SSID_{B} 131, while BSSID_{B2} (which may previously have been idle) is configured to service user (A)'s client devices.

In some embodiments, a neighboring router can be configured with multiple BSSIDs, wherein each BSSID is configurable with multiple SSIDs. For example, router BSSID_{F} 115 may also be configurable with additional BSSIDs (e.g., BSSID_{F2} and BSSID_{F3}, not shown). Users (C), (D), (G), and (H) (not shown) may be associated with routers BSSID_{C} 112, BSSID_{D} 113, BSSID_{G} 116, and BSSID_{H} 117, respectively. In the example, router BSSID_{F} 115 has a better signal strength at the location of the client device of user (C) than that of router BSSID_{C} 112. Similarly, router BSSID_{F} 115 has a better signal strength at the location of the client device of users (D), (G), and (H) than that of routers BSSID_{D} 113, BSSID_{G} 116, and BSSID_{H} 117, respectively. The BSSIDs of router BSSID_{F} 115 may be configured such that BSSID_{F} 115 services user (B)'s client devices (using SSID_{B} 131); BSSID_{F2} services user (C)'s client devices (using SSID_{C} 132) and user (D)'s client devices (using SSID_{D} 133); and BSSID_{F3} services user (G)'s client devices (using SSID_{G} 136) and user (H)'s client devices (using SSID_{H} 137).

In an embodiment, the network connection manager determines whether sufficient bandwidth is available to provision over the temporary connection between user (A)'s client device and its neighboring router BSSID_{B} 111. For example, the client device may send a bandwidth request to router BSSID_{B} 111. In another example, the network connection manager may set a predetermined bandwidth to be provisioned for new client devices connecting router BSSID_{B} 111. The predetermined bandwidth and/or the requested bandwidth may be greater than the bandwidth experienced when the client device is connected to its assigned router (e.g., assigned router BSSID_{A} 110). The network connection manager may determine the quiescent bandwidth (also referred to as available bandwidth) of the neighboring router BSSID_{B} 111. The quiescent bandwidth may be calculated by determining the average bandwidth usage of router BSSID_{B} 111, and whether such usage allows for headroom to allocate the requested (or predetermined) bandwidth to the client device. If so, the ISP provisions bandwidth over this connection to the client device (by way of SSID_{A} 130), while continuing to provision client devices of router BSSID_{B} 111 (by way of SSID_{B} 131).

In an embodiment, routers which have low RF signal strength (e.g., to one or more client devices currently engaged in active Wi-Fi communication with the router) are selectively disabled. For example, based on the evidentiary report, the network connection manager may determine that router BSSID_{A} 110 has low signal strength and thus can temporarily disable it. In an embodiment, when a router is disabled, it does not broadcast any SSID and does not accept new client devices. In an embodiment, the disabled router may be reactivated based on various factors, such as after a predetermined time has lapsed, if the signal strength of the disabled router returns above a certain level (e.g., the location, or other characteristic or condition, of one or more client devices changes such that the signal strength of the disabled router at the one or more client devices is above a certain level), etc.

In an embodiment, the disabled routers may temporarily serve as a client device which assesses link quality of neighboring active routers in real-time. For example, the disabled routers may periodically collect signal strength data of neighboring routers (such as the RSSI level, location of the routers, signal strengths at different times, etc.) in an evidentiary report. The network connection manager may dynamically disable or reactivate routers based on the evidentiary report.

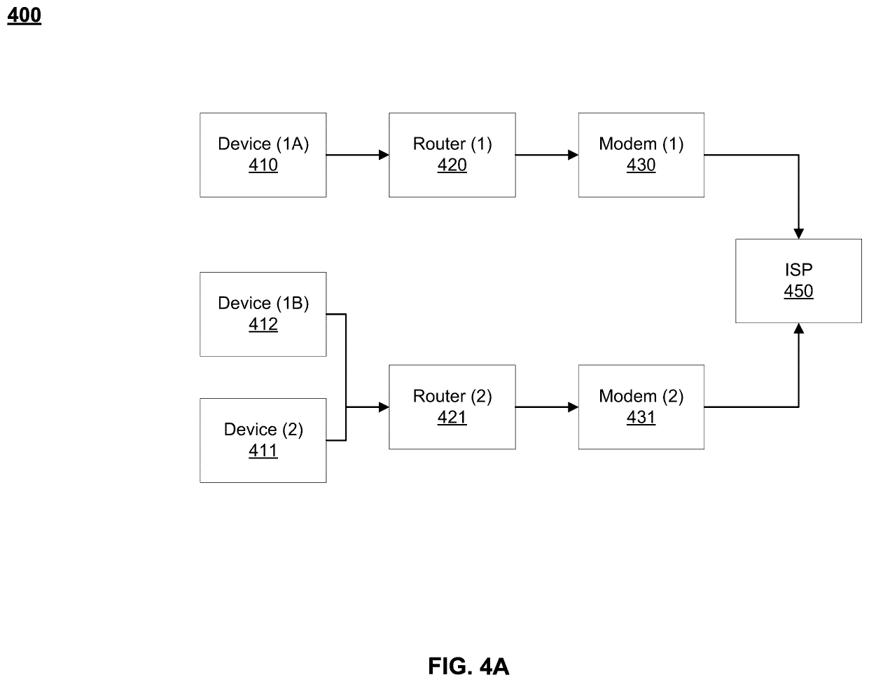

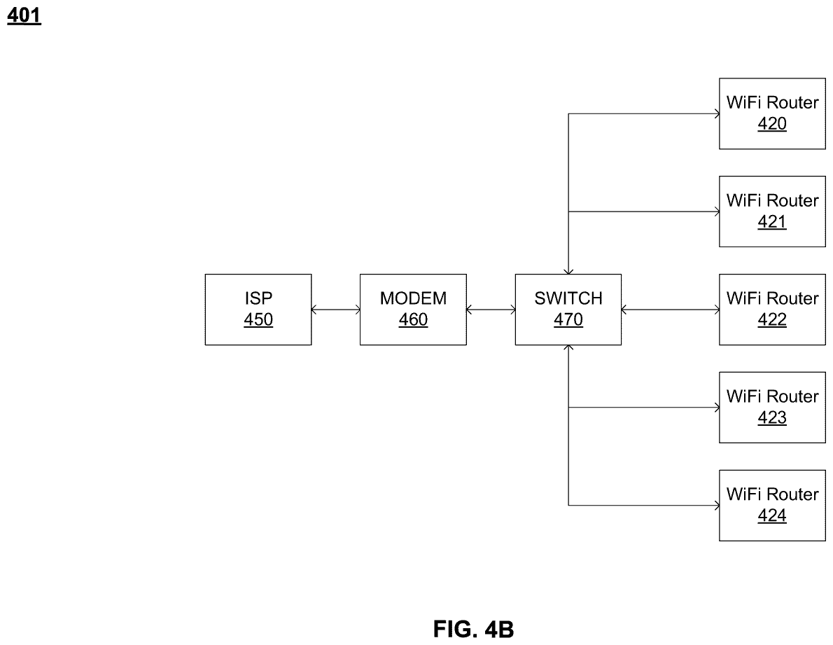

In some embodiments, a switch is installed to the front-end of all routers, to maintain LAN device visibility on the private network and ensure LAN privacy when client devices are dynamically connected with different routers. For example, such architecture allows LAN devices to remain visible on the private network independent of which router the devices are connected to. Meanwhile, the architecture also prevents LAN traffic from exiting the boundaries of the LAN. Such architecture is discussed in further detail in FIGS. 4A and 4B.

FIG. 2 shows an illustrative environment 200 in which a system of dynamically configuring Wi-Fi coverage in a high-density wireless environment is implemented, in accordance with various embodiments of this disclosure. In an embodiment, environment 200 comprises an internet service provider (ISP) 260, network connection manager 250, and multiple homes 201, 202. In some embodiments, homes 201, 202 comprise units within businesses, or other suitable units of a high-density wireless environment wherein each unit includes at least one access point. Each home or unit may be associated with a user (e.g., customer of ISP 260) and include a customer-assigned access point and at least one client device (e.g., of the user). For instance, the user may have a user account subscribing to internet services from the ISP 260, which ISP 260 assigns the access point (for instance, a customer-assigned router) to the user account. The user account may also be associated with a customer-specific SSID for use with the access point. The customer-assigned access point originates and is configured with the customer-specific SSID of the user account. The customer-specific SSID may be a private SSID, and thus is only visible to client devices of the user (e.g., client devices associated with the user account and/or client devices located within the user's home or unit). Client devices associated with the user account and/or located in the user's home or unit receive wireless internet connection from the access point using the customer-specific SSID. The customer-specific SSID may be stored in the wireless profile of each client device. A client device and/or assigned access point may be located within a certain distance of a neighboring access point (e.g., neighboring router). In another example, neighboring access points are those which are detectable by the client device (e.g., from the client device's location). In an embodiment, when the signal quality from an assigned access point to a client device is low, the client device can be connected to and receive higher quality signal from a neighboring access point while continuing to use (e.g., carrying over) the customer-specific SSID (e.g., of the wireless profile of the client device/as originated by the assigned access point). In some embodiments, other user-specific data may be carried over with the client device when connected with a neighboring access point, such as parental controls, other network settings, etc.

In the example, home (A) 201 comprises customer-assigned router (A) 210 and client device (A) 220. Router (A) 210 is identified by a BSSID of BSSID_{A} 110 and originates a customer-specific SSID of SSID_{A} 130. The customer-specific SSID_{A} 130 is stored in the wireless profile of client device (A) 220, which receives wireless internet connection from router (A) 210 under SSID_{A} 130. With respect to client device (A) 220 (and other client devices in home (A) 201), router (A) 210 is the assigned router while router (B) 211 (and other access points from other homes or units) is a neighboring router. Home B 202 comprises customer-assigned router (B) 211 and client device (B) 221. Router (B) 211 is identified by a BSSID of BSSID_{B} 111 and originates a customer-specific SSID of SSID_{B} 131. The customer-specific SSID_{B} 131 is stored in the wireless profile of client device (B) 221, which receives wireless internet connection from router (B) 221 under SSID_{B} 131. With respect to client device (B) 221, (and other client devices in home (B) 202), router B 211 is the assigned router while router (A) 210 (and other access points from other homes or units) is a neighboring router.

ISP 260 comprises a network service provider of homes 201, 202. Routers 210, 211 belong to/managed by ISP 260 and/or network connection manager 250. In an embodiment a single ISP 260 is associated with routers 210, 211. In another embodiment, different ISPs may be associated with each router, and a third-party aggregator (such as network connection manager 250) may manage between the multiple routers and multiple ISPs. In an embodiment, the ISP may assign a private SSID (e.g., customer-specific SSID) for each BSSID (router).

Network connection manager 250 is operable as a network orchestrator of the wireless network and the backhaul network portion (e.g., wired network such as hybrid fiber-coaxial (HFC) network). In some embodiments, the system may comprise two network connections managers (for instance, a Wi-Fi orchestrator such as OpenSync, and another orchestrator for the backhaul). In another embodiment, network connection manager 250 may be an aggregate manager of multiple sub-orchestrators (e.g., Wi-Fi sub-orchestrator and backhaul sub-orchestrator. In some embodiments, network connection manager 250 also serves as a third-party aggregate manager for multiple ISPs (e.g., in the situation where router 210 is associated with a first ISP and router 211 is associated with a second ISP). In some embodiments, network connection manager 250 resides in the ISP network.

In an embodiment, if client device (A) 220 detects that the RF signal strength received from assigned router (A) 210 is weak, then the connection between client device (A) 220 and router (A) 210 may be automatically terminated, while an alternate connection between client device (A) 220 and a neighboring router (e.g., router (B) 211) using the customer-specific SSID_{A} 130 is automatically established. For instance, the RF signal strength received at the location of client device (A) 220 may be below a threshold or a desired strength. RF signal strength may be measured by received signal strength indicator (RSSI) levels. Based on the detection, client device (A) 220 may send data to network connection manager 250 indicating that a neighboring router (such as router (B) 211) that has a stronger RF signal than assigned router (A) 210. For example, client device (A) 220 may compile an evidentiary report to send to network connection manager 250. In some embodiments, the evidentiary report is compiled periodically, and/or any collection of data for an evidentiary report (such as speed tests) is performed periodically. The evidentiary report may include any one or a combination of: the customer-specific SSID (e.g., as stored in a wireless profile of the client device, such as SSID_{A} 130 for client device (A) 220); BSSID of the assigned router (e.g., BSSID_{A} 110); signal strength of the assigned router (e.g., RSSI of router (A) 210); speed test results of the connection from the assigned router (e.g., bandwidth or throughput of router (A) 210); signal strength and BSSID(s) of a neighboring router(s) (e.g., of router (B) 211), among other information relating to the signal strength or QoS provided to the client device's location by the assigned router and/or neighboring router(s) (e.g., location information of the client device, assigned router, available bandwidth and/or bandwidth usage from each router, etc.).

For example, upon detecting low RF signal strength from assigned router (A) 210, client device 220 may perform a speed test of assigned router (A) 210. Client device (A) 220 may also collect signal strength data of neighboring router (B) 211 (or other neighboring routers within a particular distance of client device (A) 220 and/or which have a detectable signal of a certain level from the current location of client device (A) 220). Client device (A) 220 may compile an evidentiary report comprising the customer-specific SSID as stored in its wireless profile/originated by its assigned router (e.g., SSID_{A} 130), the BSSID of its assigned router (e.g., BSSID_{A} 110), signal strength of its assigned router (e.g., RSSI of assigned router (A) 210), signal strengths of neighboring routers (e.g., RSSI of neighboring router (B) 211), BSSIDs of neighboring routers (e.g., BSSID_{B} 111 for neighboring router (B) 211), speed test results of assigned router (A) 210, and the like. The evidentiary report is sent to network connection manager 250 for determining whether a neighboring router can be configured to service the client device. In some embodiments, the evidentiary report may also include a QoS request (e.g., preferred QoS or minimum QoS to be provisioned over the connection with the neighboring router) of client device (A) 220. For instance, an application operating on client device (A) 220 may require a particular QoS (e.g., a streaming video application may require low latency or is bandwidth intensive).

In an embodiment, network connection manager 250, evaluates the evidentiary report to determine whether a neighboring router can be configured to service a client device (using the customer-specific SSID of that client device) of another unit (e.g., user account) without compromising quality of service to client devices of its own unit (e.g., user account). In some embodiments, the evidentiary report is periodically sent to connection network manager 250, which automatically evaluates the evidentiary report to determine whether to connect client device (A) 220 with neighboring router (B) 211. In the example, network connection manager 250 may determine based on the evidentiary report that the RSSI and speed test results of its assigned router (A) 210 are each low (e.g., below a certain QoS value) with respect to client device (A) 220 and its current location. Network connection manager 250 also determines whether the signal strength of the neighboring router (B) 211 is greater than the signal strength of the assigned router (A) 210. Network connection manager 250 may also determine whether neighboring router (B) 211 is associated with the same ISP 260 as that of assigned router (A) 210, or otherwise within control of the network connection manager 250 (e.g., where network connection manager 250 is a third-party aggregate network manager of multiple ISPs).

Upon determining that the signal strength of neighboring router (B) 211 is greater than that of assigned router (A) 210, network connection manager 250 determines whether the neighboring router (B) 211 has enough quiescent bandwidth (e.g., available bandwidth) to serve both the client device (A) 220 of the assigned router as well as its own client device(s) (e.g., client device (B) 221). In an example, a bandwidth request may be included in the evidentiary report. Additionally, or alternatively, client device (A) 220 may send the bandwidth request to neighboring router (B) 211 (which sends the request to the connection manager 250 through a wired connection of the ISP) once they are connected. In an embodiment, the bandwidth request includes a preferred QoS or minimum QoS. For instance, client device (A) 220 requests 100 Mbps of bandwidth from a neighboring router. In another embodiment, network connection manager 250 determines a default or a minimum QoS with which to provision client device (A) 210 from a neighboring router. In another embodiment, the network connection manager 250 may determine a default QoS value based on peak usage from client device (A) 220 when served by its assigned router (e.g., when the signal strength was strong between assigned router (A) 210 and client device (A) 220; or based on a history of bandwidth usage by client device (A) 220 from assigned router (A) 210). In yet another embodiment, the QoS to be allocated to client device (A) 220 may be based on the number of other client devices competing for connection to the neighboring router.

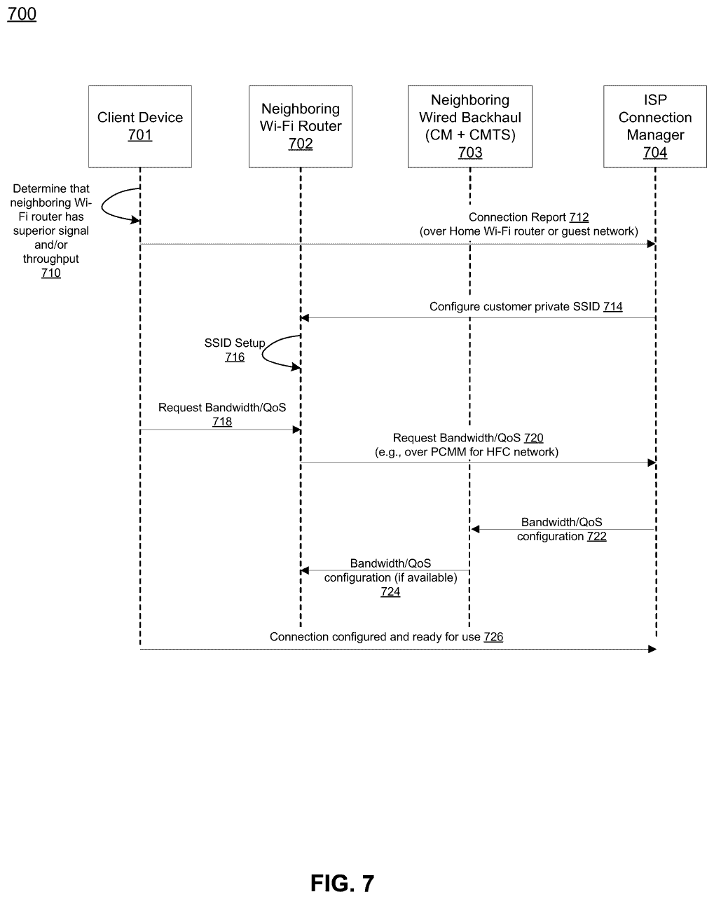

In an embodiment, available bandwidth is sufficient if it allows for enough headroom for client device (A) 220 to receive reserved bandwidth. For example, the available bandwidth may be sufficient if it is greater than a value predetermined by network connection manager 250. In another example, the available bandwidth is sufficient if it is greater than a QoS requested by (or predetermined for) client device (A) 220. In an embodiment, the available bandwidth of neighboring router (B) 211 is calculated based on subtracting its typical bandwidth usage from its bandwidth capacity. For example, the typical bandwidth usage may be the average bandwidth usage over a period of time consumed by client device (B) 221 (and other client devices associated with router (B) 211/home (B) 202). In an example, the bandwidth capacity may be the maximum bandwidth according to the SLA of the user account associated with router (B) 211 (e.g., the maximum bandwidth paid for by such user account). In another example, the bandwidth capacity may be the maximum bandwidth which the router (B) 211 is physically capable of serving. If the available bandwidth is sufficient, network connection manager 250 dynamically configures a temporary connection between client device (A) 220 and neighboring router (B) 211 using the customer-specific SSID_{A} 130 of client device (A) 220. In an embodiment, network connection manager 250 configures neighboring router (B) 211 with the customer-specific SSID_{A} 130, allowing client device (A) 220 to join neighboring router (B) 211 using its exclusive SSID. Once connected, ISP 260 may provision client device (A) 220 with the (requested or predetermined) QoS over neighboring router (B) 211. Dynamic configuration of neighboring router (B) 211 is described in further detail in FIG. 7.

In an embodiment, when multiple neighboring routers are available and capable of serving client device (A) 220, network connection manager 250 selects which neighboring router to connect with client device (A) 220 based on various factors. Factors can include, for example, which neighboring router has the highest available bandwidth, which neighboring router has the strongest RF signal, which neighboring device is closest in distance to the client device, whether the client device (A) 220 recently or previously connected with the neighboring router, a combination thereof, and the like.

In an embodiment, the connection is terminated if the available bandwidth neighboring router (B) 211 can no longer meet the QoS of the client device (A) 220 and/or the signal strength of the neighboring router (B) 211 drops below a certain value. In addition, or alternatively, the connection may be terminated if the signal strength of assigned router (A) 210 returns above a certain value. In addition, or alternatively, the connection may be terminated if client device (A) 220 relocates (e.g., is no longer within range of neighboring router (B) 211).

In an embodiment, when the connection between the client device (A) 220 and router (B) 211 is terminated, client device (A) is automatically connected with another router (or reconnected with its original router (A) 210) such that the client device experiences seamless and continuous QoS. For example, in some embodiments, when the connection is terminated and/or when the available bandwidth or signal strength of the neighboring router (B) 211 drops below a certain value, client device (A) 220 may send another (e.g., updated) evidentiary report to network connection manager 250, which the network connection manager 250 uses to identify another neighboring router which can serve the client device (A) 220 using the client device's customer-specific SSID_{A} 130. In another embodiment, where the signal strength of the assigned router (A) 210 returns above a certain value (e.g., client device (A) 220 moves to a location closer to assigned router (A) 210), client device (A) 220 is automatically reconnected with its assigned router (A) 210.

In some embodiments, client device (A) 220 is associated with a location profile, which network connection manager 250 may use to automatically configure the client device (A) 220 with an eligible neighboring router when its assigned router (A) 210 (or other currently connected router) has low signal strength. The location profile can comprise a current location fingerprint and/or previous location fingerprints of the client device (A) 220. In an embodiment, the location profile may include various data such as identifying the neighboring router(s) with which the client device (A) 220 previously connected in a particular location, historical times and dates of the connections, signal strength data and/or bandwidth usage data of the neighboring routers in the location, and the like. In an embodiment, the location profile may be generated based on RSSI levels from neighboring routers (e.g., resulting in a coarse-grained location profile). In another embodiment, the location profile may be generated based on channel state information (CSI) matrices of links with neighboring routers, which may provide a more precise location fingerprint of client device (A) 220 (e.g., resulting in a fine-grained location profile). In an example, when client device (A) 220 returns to a historically low signal strength area, network connection manager 250 may determine the optimal neighboring router for a connection, based on the location profile of client device (A) 220. For instance, the optimal neighboring router may be the router with the historically strongest signal in the area, the router with which client device (A) 220 previously connected most frequently or most recently, etc. Network connection manager 250 may automatically configure the optimal neighboring router with the customer-specific SSID_{A} 130 of client device (A) 220 and create the connection. In another example, if network connection manager 250 detects a change in the location fingerprint of client device (A) 220 (e.g., client device (A) 220 is no longer at the current location), network connection manager 250 may automatically terminate the connection between client device (A) 220 and the neighboring router.

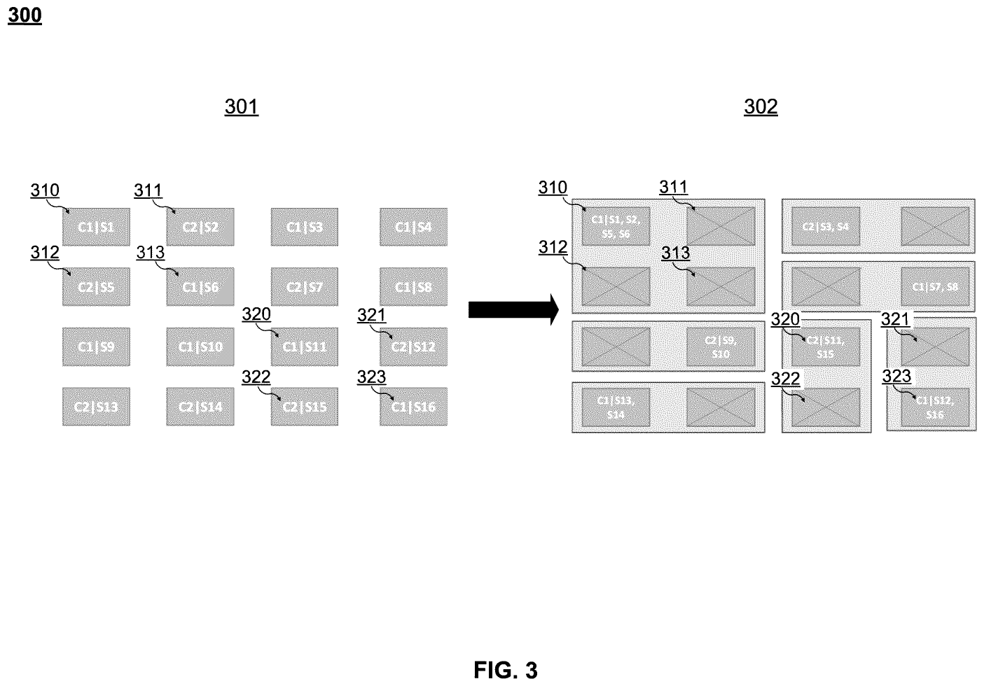

FIG. 3 shows an illustrative map 300 of channel configuration and Wi-Fi coverage using a system of dynamically configuring Wi-Fi coverage in a high-density wireless environment, in accordance with various embodiments of the disclosure. In the example, step 301 shows a high-density wireless environment of a plurality of access points which are all active. At step 302, network connection manager 250 may selectively disable a subset of the access points.

In an example, when signal strength of router 311 is low (e.g., at the location of the client device), the client device associated with (assigned) router 311 may compile an evidentiary report that (neighboring) router 310 has a stronger signal at the client device. Network connection manager 250 can configure neighboring router 310 with the customer specific SSID of the client device (e.g., SSID (S2)), allowing the client device to connect with neighboring router 310 and receive internet connection. Network connection manager 250 can also temporarily disable assigned router 311 (e.g., until its signal strength is above a certain level).

In an embodiment, access points may be disabled based on various factors, such as their signal strength, available bandwidth, etc. For example, network connection manager 250 may determine those access points which have low RF signal strength (e.g., a signal below a certain strength at a certain location of a client device or within a certain range of the access point) and disable them (e.g., such that they do not broadcast any SSID or accept new client devices). In an embodiment, each remaining active router is configured with the customer-specific SSIDs originated by its disabled neighboring routers and serves the neighboring client devices on a single channel using their respective customer-specific SSID. This reduces the number of channels used and thereby reduces risk of congestion and interference and maximizes signal quality and performance of access points in the high-density wireless environment. In the example, at step 301, routers 310, 311, 312, and 313 are active and each serve client devices using their respective customer-specific SSIDs (e.g., router 310 with SSID (S1), router 311 with SSID (S2), router 312 with SSID (S5), and router 313 with SSID (S6)). At step 302, network connection manager 250 determines that the signal strengths of routers 311, 312, and 313 are below a certain strength. Additionally, or alternatively, network connection manager 250 may determine that the signal strength of router 310 is above a certain strength and/or above the strengths of each of routers 311, 312, and 313. Based on such determination(s), network connection manager 250 may disable routers 311, 312, and 313 and configure router 310 with the customer-specific SSIDs of the disabled routers in addition to its own customer-specific SSID (e.g., router 310 is configured with SSIDs (S1), (S2), (S5), and (S6)). Thus, the active router 310 can serve multiple client devices associated with the disabled routers 311, 312, 313.

In some embodiments, network connection manager 250 may determine that although a router has a low signal strength for a given client device, the router nonetheless has an acceptable signal strength for another client device(s) and may remain active. For example, neighboring router 320 may have low signal strength for client devices of router 321 (which is associated with SSID (S12)), but has an acceptable signal strength for client devices of router 322 (which is associated with SSID (S15)). Thus, router 320 may remain active and be configured with SSID (S15) to service client devices of router 322 (in addition to servicing its own client devices using SSID (S11)). Meanwhile, router 323 may be configured with SSID (S12) to service client devices of router 321 (in addition to servicing its own client devices using SSID (S16)).

In another embodiment, an active router is configured with all of the SSIDs in the area of the coverage map 300. For example, where the coverage map 300 includes sixteen access points (each with respective SSIDs), active router 310 (and/or any other active router) may be configured with all sixteen SSIDs (e.g., SSID (S1)-(S16)).

In an embodiment, a disabled router may serve as a monitoring client device which assesses link quality of the neighboring active router in real time. For example, any one or a combination of disabled routers 311, 312, 313 may determine the signal strength of or perform a speed test on router 310 (and other neighboring routers) and compile an evidentiary report. Network connection manager 250 may dynamically disable or reactivate routers based on the evidentiary reports, thus dynamically switching routers between router mode and client mode. In yet another embodiment, a disabled router may serve as a Wi-Fi extender of a neighboring active router (e.g., the router is dynamically switched between router mode and extender mode).

FIG. 4A shows an illustrative diagram 400 of internet traffic of devices serviced by a neighboring router, in accordance with various embodiments of the disclosure. In the example, devices (1A) 410 and (1B) 412 belong to a user (1) (not shown) of (assigned) router (1) 420. (Neighboring) device (2) belongs to a user (2) (not shown) of (neighboring) router (2) 421. Suppose device (1B) 412 has been connected with router (2) 421 using its customer-specific SSID (e.g., originated by router (1) 420). If a user on a subnet wishes to access one of their LAN devices, the device needs to show up on the same subnet and be visible from their router. Thus, for user (1) to access device (1B) 412 (for instance, pair device (1B) 412 with device (1A) 410 which remains with the private network associated with router (1) 420), device (1B) 412 must be visible on the same private network as that of device (1A) 410. Similarly, as device (1B) 412 belongs to user (1), it is important that it does not show as a LAN device for router (2) 421. It is also important to ensure that LAN traffic associated with the device (1B) 412 (e.g., when connected with a neighboring router) remains within the boundaries of the LAN, and to prevent such traffic from traversing over router (2) 421 and modem (2) 431 to the ISP 450. Techniques for ensuring visibility of LAN devices when connected to a neighboring router and for maintaining LAN traffic within the LAN boundaries are described further with respect to FIG. 4B.

FIG. 4B shows an illustrative architecture 401 of managing internet traffic in a high-density wireless environment, in accordance with various embodiments of the disclosure. In an embodiment, architecture 401 comprises switch (or load balancer) 470 installed to the front-end of all access points (routers 420, 421, 422, 423, 424, etc.) in the high-density wireless environment. For multiple routers that are associated with the same ISP 450, a single modem 460 (also associated with ISP 450) may be installed between the switch 470 and ISP 450. In another embodiment, switch 470 can direct traffic between routers and multiple modem/ISP pairs based on a corresponding ISP associated with the router. As a result of architecture 401, LAN traffic is prevented from exiting the boundaries of the LAN. For example, if device (1A) 410 remains connected with its assigned router (1) 420 and device (1B) 412 has connected with neighboring router (2) 421, device (1A) 410 and device (1B) 412 may communicate wirelessly because switch 470 directs LAN traffic between routers 420 and 421. Additionally, communications between device (1A) 410 and device (1B) 412 will remain within the LAN boundary, as switch 470 directs LAN traffic between routers 420 and 421, thereby preventing the LAN traffic from traversing modem 460.

In an embodiment, changes made to a subnet (for instance, when a user changes settings on their subnet such as parental controls, etc.), the changes are propagated to all routers under architecture 401.

In another embodiment, based on LAN settings (e.g., user preferences), a client device may be preferentially connected with its assigned router instead of the neighboring router, even though the neighboring router has stronger signal strength and/or better bandwidth. For example, if device-to-cloud communications is detected (e.g., device (1B) 412 is a mobile device which communicates with a cloud server), and the neighboring router (e.g., router (2) 421) has better signal than the assigned router (e.g., router (1) 420), device (1B) 412 may be automatically connected with the neighboring router. However, a user may desire to contain device-to-device communications within their assigned router (e.g., keep the device-to-device communications from being sent over a neighboring router). Thus, if device-to-device communication is detected (e.g., mobile device (1B) 412 communicates with device (1A) 410 which is a printer), device (1B) 412 may remain connected, or is reconnected, with its assigned router (1) 420.

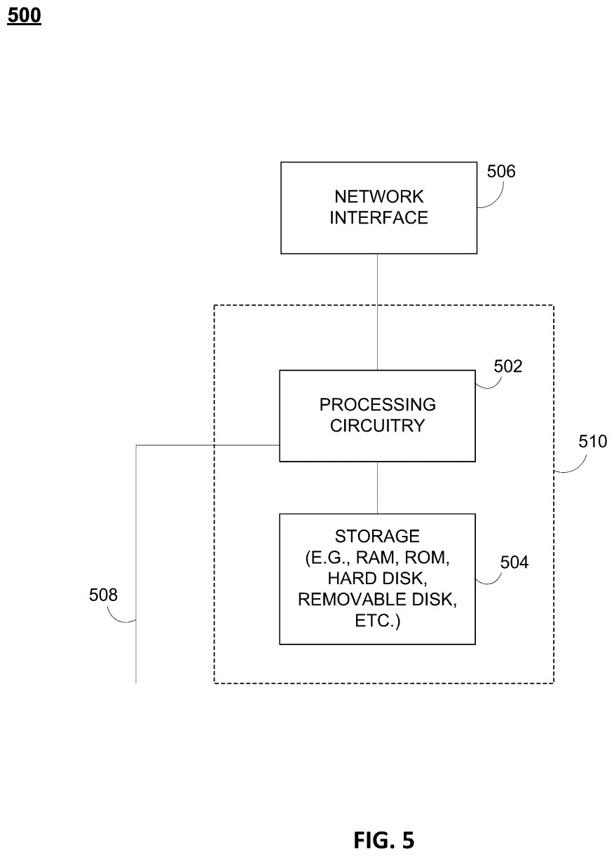

FIG. 5 shows an illustrative block diagram of a network device 500, in accordance with some embodiments of the disclosure. In particular, network device 500 of FIG. 5 may be any of the devices depicted in FIG. 1 (e.g., BSSIDs 110, 111, 112, 113, 114, 115, 116, 117, 118, 119, 120, and 121), FIG. 2 (e.g., routers 210, 211), FIG. 3 (e.g., routers 310, 311, 312, 313, 320, 321, 322, 323), FIGS. 4A and 4B (e.g., routers 420, 421, modems 430, 431, and switch 470), and/or FIG. 7 (e.g., neighboring Wi-Fi router 702, neighboring wired backhaul components 703), or may be a physical or virtual device hosting any of physical or virtual devices. In some embodiments, network device 500 may be an access point, such as a router, an L3 switch, an L2 router, a host, wireless repeater or wireless range extender, and/or any other computing device that may be configured to connect a wireless device to a wired network. Network device 500 may include one or more computer systems (e.g., computing devices), such as a desktop computer, a laptop computer, and a tablet computer with mobile hotspot capabilities. In some embodiments, the network device 500 is a data server that hosts one or more databases, models, or modules or may provide various executable applications or modules. In practice, and as recognized by those of ordinary skill in the art, items shown separately could be combined and some items could be separated. In some embodiments, not all shown items must be included in network device 500. In some embodiments, network device 500 may comprise additional items.

The network device 500 can include processing circuitry 502 that includes one or more processing units (processors or cores) that may communicate with storage 504, and/or a network interface 506 via input/output (I/O) paths 508. I/O paths 508 may use communication buses for interconnecting the described components. I/O paths 508 can include circuitry (sometimes called a chipset) that interconnects and controls communications between system components. Network device 500 may receive data via I/O paths 508. The I/O path 508 may provide data to control circuitry 810, which includes processing circuitry 502 and a storage 504. The control circuitry 510 may be used to send and receive commands, requests, and other suitable data using the I/O path 508. The I/O path 508 may connect the control circuitry 510 (and specifically the processing circuitry 502) to one or more communications paths. I/O functions may be provided by one or more of these communications paths but are shown as a single path in FIG. 5 to avoid overcomplicating the drawing.

The control circuitry 510 may be based on any suitable processing circuitry such as the processing circuitry 502. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 504 that is part of the control circuitry 510. Storage 504 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, solid state devices (SSDs), quantum storage devices, any other suitable fixed or removable storage devices, and/or any combination of the same.

In some embodiments, storage 504 or the computer-readable storage medium of the storage 504 stores an operating system, which includes procedures for handling various basic system services and for performing hardware dependent tasks. In some embodiments, storage 504 or the computer-readable storage medium of the storage 504 stores a communications module, which is used for connecting the network device 500 to other computers and devices via the one or more communication network interfaces 506 (wired or wireless), such as the internet, other wide area networks, local area networks, metropolitan area networks, and so on. In some embodiments, storage 504 or the computer-readable storage medium of the storage 504 stores a web browser (or other application capable of displaying web pages), which enables a user to communicate over a network with remote computers or devices.

In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 504 stores a subset of the modules and data structures identified above. In some embodiments, the storage 504 may store additional modules or data structures not described above.

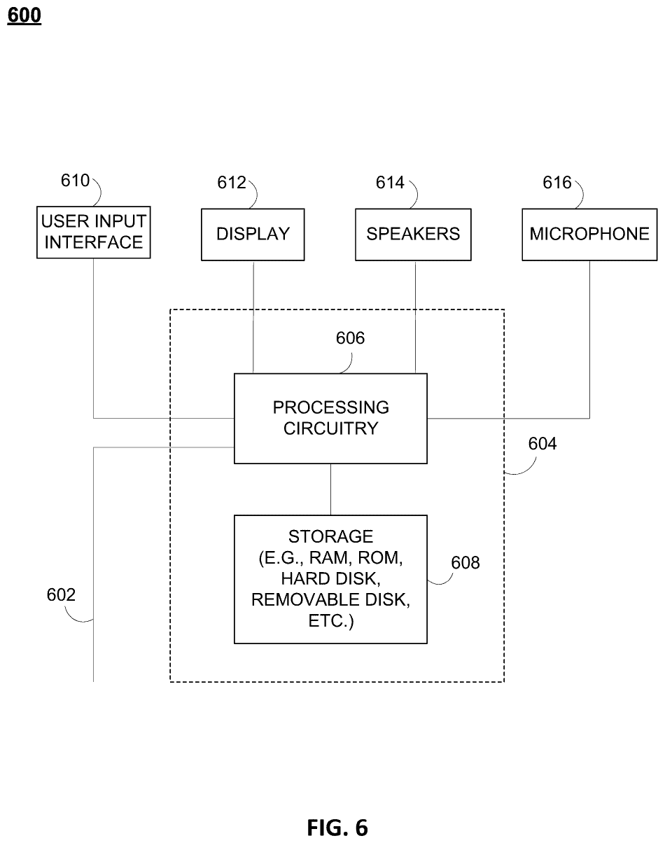

FIG. 6 shows a generalized embodiment of a user equipment device 600, in accordance with some embodiments. In an embodiment, the user equipment device 600 is an example of the user equipment devices described in FIG. 1 (e.g., client devices 220, 221), FIG. 4A (e.g., devices 410, 412, 411), and/or FIG. 7 (e.g., client device 701). In some embodiments, the user equipment device 600 may receive content and data via I/O path 602. The I/O path 602 may provide content (e.g., video conferences, emails, instance messages, broadcast programming, on-demand programming, Internet content, content available over a local area network (LAN) or wide area network (WAN), and/or other content) and data to control circuitry 604, which includes processing circuitry 606 and a storage 608. The control circuitry 604 may be used to send and receive commands, requests, and other suitable data using the I/O path 602. The I/O path 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The reconfiguring of a user's access network to provide varying QoS functionality can be at least partially implemented using the control circuitry 604. The reconfiguring of a user's access network to provide varying QoS functionality described herein may be implemented in or supported by any suitable software, hardware, or combination thereof.

In client-server-based embodiments, the control circuitry 604 may include communications circuitry suitable for communicating with one or more servers that may at least implement the described reconfiguring of a user's access network to provide varying QoS functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 608 may be used to store various types of data described herein. Nonvolatile memory may also be used (e.g., to launch a boot-up routine and other instructions). Cloud-based storage may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604, which are received by the microphone 616. The microphone 616 may be any microphone (or microphones) capable of detecting human speech. The microphone 616 may be connected to the processing circuitry 606 to transmit detected voice commands and other speech thereto for processing. In some embodiments, voice assistants (e.g., Siri, Alexa, Google Home and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touchscreen or touch-sensitive display. In such circumstances, the interface 610 may be integrated with or combined with the microphone 616. When the interface 610 is configured with a screen, such a screen may be one or more of a monitor, a television, a liquid crystal display (“LCD”) for a mobile device, active matrix display, cathode ray tube display, light-emitting diode display, organic light-emitting diode display, quantum dot display, or any other suitable equipment for displaying visual images. In some embodiments, the interface 610 may be HDTV-capable. In some embodiments, the display 612 may be a 3D display. A speaker 614 may be controlled by the control circuitry 604. The speaker (or speakers) 614 may be provided as integrated with other elements of user equipment device 600 or may be a stand-alone unit. In some embodiments, the display 612 may be outputted through speaker 614.

FIG. 7 shows an illustrative system sequence diagram of a process 700 of dynamically configuring Wi-Fi coverage in a high-density wireless environment, in accordance with various embodiments of the disclosure. The process 700 may be implemented, in whole or in part, by the networking device 500 shown in FIG. 5 and/or the user equipment 600 as shown in FIG. 6. One or more actions of the process 700 may be incorporated into or combined with one or more actions of any other process or embodiments described herein. The process 700 may be saved to a memory or storage (such as any one or more of those shown in FIG. 5) as one or more instructions or routines that may be executed by a corresponding device (such as that shown in FIG. 6) or system to implement the process 700. Depending on the embodiment, one or more steps of the described process may be implemented or facilitated by a server.

In an embodiment, the system comprises client device 701, neighboring Wi-Fi router 702, neighboring wired backhaul link 703, and internet service provider (ISP) connection manager 704 (previously referenced as network connection manager 250). Client device 701 can comprise any suitable wireless computing device, which is associated with a customer-assigned router (not shown) using a customer-specific SSID originated by the assigned router and stored in a wireless profile of client device 701. Neighboring Wi-Fi router 702 comprises any access point that is within a particular distance of the assigned router (and/or of the client device 701, e.g., is visible to or detectable by client device 701).

In an embodiment, neighboring wired backhaul 703 comprises backhaul for a wired network, such as Hybrid Fiber-Coaxial (HFC) network. For example, neighboring wired backhaul link 703 can comprise a (wired) link between a cable modem (CM) and a cable modem termination system (CMTS) associated with an ISP that provisions wireless connection to client device 701. In another embodiment, neighboring wired backhaul 703 can comprise backhaul for satellite network, fiber network, 5G network, or other suitable mediums which provision bandwidth.

In an embodiment, connection manager 704 can be network orchestrator of the wireless network and the backhaul link. In some embodiments, the system may comprise two connections managers (for instance, a Wi-Fi orchestrator such as OpenSync, and another orchestrator for the backhaul). In another embodiment, connection manager 704 may be an aggregate manager of multiple sub-orchestrators (e.g., Wi-Fi sub-orchestrator and backhaul sub-orchestrator).

At step 710, client device 701 detects low RF signal strength and/or throughput from its assigned router. Additionally, or alternatively, client device 701 determines that neighboring router 702 has superior signal and/or throughput to that of its assigned router. Signal strength data and throughput data may be obtained, for instance, by measuring RSSI levels or performing a speed test.

At step 712, client device 701 compiles an evidentiary report (also referred to as a connection report), which can be used by connection manager 704 to determine whether neighboring router 702 is capable of serving client device 701. In an embodiment, the evidentiary report may include any one or a combination of: the customer-specific SSID (e.g., as stored in a wireless profile of the client device 701); BSSID of the assigned router; signal strength and/or speed test results of the assigned router; BSSID of neighboring router 702; signal strength of neighboring router 702; other data relating to the signal strength or QoS available of the assigned router and/or neighboring router(s) with respect to the client device's 701 location (e.g., location information of the client device 701, available bandwidth and/or bandwidth usage from each router), and so forth. In some embodiments, the evidentiary report may be generated and sent periodically.

At step 714, connection manager 704 configures neighboring router 702 with the customer-specific SSID of client device 701. In an embodiment, the customer-specific SSID is a private SSID and is only visible to client device 701.

At step 716, neighboring router 702 is set up with the customer-specific SSID of client device 701, allowing client 701 to join (e.g., wirelessly connect with) the neighboring router 702 using its exclusive private SSID.

In an embodiment, the customer-specific SSID of client device 701 (e.g., as configured on neighboring router 702) is private. For example, when configured with the customer-specific SSID of client device 701, neighboring router 702 may advertise it as well as the SSID originally associated with the neighboring router 702. Neighboring router 702 may be automatically configured to no longer broadcast, or otherwise hide, the customer-specific SSID upon detecting that client device 701 has connected to neighboring router 702 (e.g., by way of client device's 701 customer-specific SSID). Thus, only a client device(s) which has previously connected to the SSID may be able to connect to such SSID via neighboring router 702. In some embodiments, secure messaging is sent to the client device 701 to inform it of at least the neighboring router 702. In another embodiment, existing wireless security or encryption settings (e.g., security parameters such as password and SSID name) associated with the customer-specific SSID are used to maintain the privacy of the connection. In a further embodiment, new wireless security or encryption settings are established specifically for the customer-specific SSID/BSSID connection with the neighboring router. Such new wireless security or encryption settings may be communicated securely, such as over the prior connection (e.g., customer-specific SSID/BSSID connection by way of the client device's 701 assigned router). In yet another embodiment, a location profile associated with the client device 701 may store an association between the connection with the neighboring router 702 and the location of the client device 701. When the client device 701 returns to the location, and based on its location profile, client device 701 is automatically connected with the neighboring router 702 by way of the customer-specific SSID of the client device 701.

At step 718, client 701 requests a dynamic bandwidth, for example, using DOCSIS PacketCable Multimedia (PCMM) protocol. In another embodiment, client can negotiate with connection manager for a guaranteed QoS. Systems and methods for guaranteeing QoS for a wireless connection over a network are discussed in greater detail in connection with Lal, et. al, U.S. patent application Ser. No. 18/216,076, filed Jun. 29, 2023, which is hereby incorporated by reference herein in its entirety.

At step 720, neighboring router 702 sends the bandwidth request to connection manager 704 by way of neighboring wired backhaul link 703.

At step 722, connection manager 704 determines, based on the typical bandwidth usage of neighboring router 702, whether there is enough bandwidth available for client device 701 to receive reserved bandwidth as requested. For example, connection manager 704 may determine the average traffic (e.g., bandwidth usage) of neighboring wired backhaul link 703 over a period of time. The average bandwidth usage can be compared against the maximum capacity of neighboring wired backhaul link 703. In an embodiment, the maximum capacity is the maximum capacity which the neighboring wired backhaul link 703 is physically capable of In another embodiment, the maximum capacity is the configured maximum capacity of the neighboring wired backhaul link per the SLA of the user account associated with the neighboring router 702 (e.g., the guaranteed wired bandwidth for the user account). If the difference between the average bandwidth usage and the maximum capacity is greater than the bandwidth requested by client device 701, then connection manager proceeds to configure the wired connection. In an embodiment, connection manager 704 configures and confirms the wired connection using PCMM protocol. For example, a Dynamic Service Add (DSA) three-way handshake can be used to create the dynamic connection to provision the requested bandwidth over the backhaul.

At step 724, bandwidth on the neighboring router 702 is allocated to the client device 701 (and any additional client device connected to neighboring router 702 at the time). In an example, weighted fair queuing (WFQ) may be used to determine the bandwidth allocation over the wireless network.

At step 726, the connection is configured such that client device 701 receives internet connection from neighboring router 702 while using its customer-specific SSID. In an embodiment, the connection may be terminated using a Dynamic Service Delete (DSD) handshake. The DSD handshake removes the customer-specific SSID from neighboring router 702 as well as the bandwidth allocation for client device 701.

In an embodiment, the connection automatically terminates when the signal strength and/or available bandwidth of neighboring router 702 drops to below a certain threshold. For instance, the signal strength of the neighboring router 702 to client device 701 may decrease when the location of client device 701 changes. In another instance, increased bandwidth demands on neighboring router 702 from other client devices (such as client devices which have neighboring router 703 as their assigned router) may result in a change in QoS headroom at neighboring router 702. Additionally, or alternatively, the connection terminates after a predetermined period of time. Additionally, or alternatively, the connection terminates when the client device 701 has changed location and/or is out of range of neighboring router 702. For example, client device 701 may be associated with a location profile. The location profile may be stored at client device 701 and/or with connection manager 704. The location profile can comprise a current location fingerprint and/or previous location fingerprints of the client device 701. When connection manager 704 detects a change in the location fingerprint of client device 701 (e.g., client device 701 is no longer at the location of neighboring router 702), a DSD handshake may be used to confirm successful termination of the connection.

In an embodiment, connection with another neighboring router (or reconnection with the assigned router) is established automatically when the connection with neighboring router 702 is automatically terminated. For example, suppose client device 701 changes its location fingerprint, which may result in reduced signal strength from neighboring router 702 and increased signal strength from another neighboring router or the assigned router. While a DSD handshake is used to confirm successful termination of the client device's 701 connection with neighboring router 702, a DSA handshake may be used to confirm successful connection of client device 701 with another neighboring router or its original assigned router.

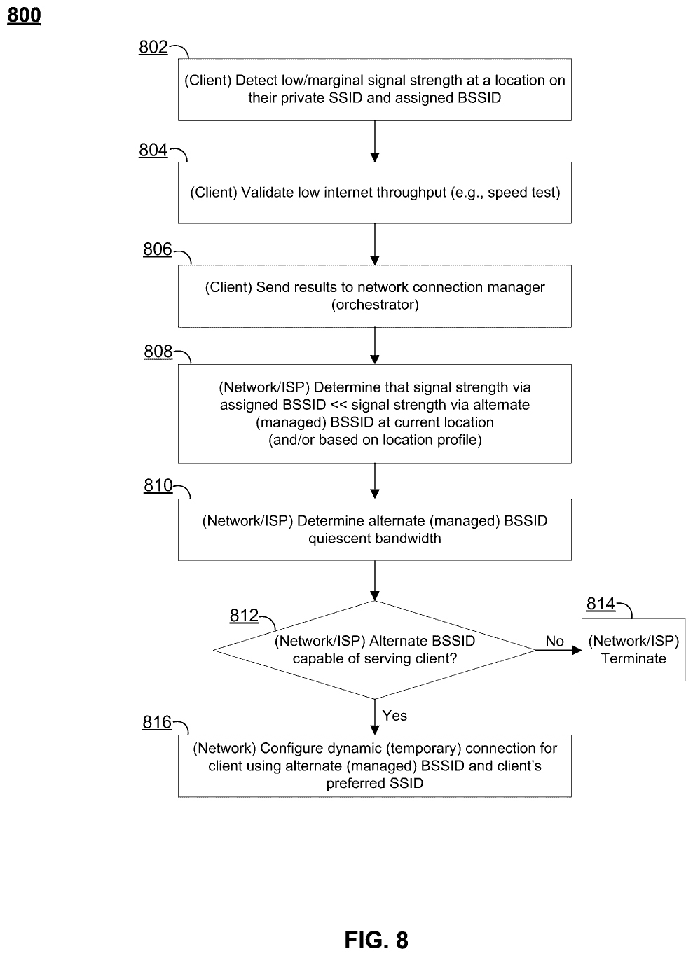

FIG. 8 shows an illustrative flowchart of a process 800 of dynamically configuring Wi-Fi coverage in a high-density wireless environment, in accordance with various embodiments of the disclosure. The process 800 may be implemented, in whole or in part, by the networking device 500 shown in FIG. 5 and/or the user equipment device 600 as shown in FIG. 6. One or more actions of the process 800 may be incorporated into or combined with one or more actions of any other process or embodiments described herein. The process 800 may be saved to a memory or storage (such as any one or more of those shown in FIG. 5) as one or more instructions or routines that may be executed by a corresponding device (such as that shown in FIG. 6) or system to implement the process 800. Depending on the embodiment, one or more steps of the described process may be implemented or facilitated by a server.

At step 802, a client device may detect low RF signal strength at its location on their customer-specific SSID (e.g., private SSID) from its assigned router. Additionally, or alternatively, the client device may determine that a neighboring router(s) (also referred to as alternate router) has stronger signal than that of its assigned router. Signal strength data may be obtained, for instance, by measuring RSSI levels at the client device.

At step 804, the client device may perform a speed test to validate that its assigned router has low internet throughput.

At step 806, the client device can compile an evidentiary report. The evidentiary report can include but is not limited to: client device location data, BSSIDs of local routers (e.g., assigned router and neighboring router(s) within a certain distance of the location of the client device), signal strength data of the local routers, speed test results of assigned router, and so forth. The evidentiary report is sent to the network connection manger (and/or the ISP by way of the network connection manager).

At step 808, based on the evidentiary report, the network connection manager determines that at the client device location, the signal strength of a neighboring router location is stronger than the signal strength of the assigned router. In some embodiments, multiple neighboring routers may each have a signal strength that is stronger than that of the assigned router. The network connection manager may select the neighboring router to connect to the client device based on one or more factors. For example, such factors can include: which neighboring router has the highest quiescent bandwidth (e.g., available bandwidth; e.g., bandwidth headroom available after serving those client devices which are already connected to the neighboring router), which neighboring router has the strongest signal strength, which neighboring router was most recently and/or most frequently connected with the client device, which neighboring router is closest in distance to the client device, or a combination thereof, among others.

In another embodiment, the network connection manager determines which neighboring router to connect with the client device based on information of the location profile associated with the client device. The location profile may comprise a current location fingerprint and/or previous location fingerprints of the client device. In some embodiments, the location profile also includes router data, such as the BSSID and signal strength patterns over various periods of time of the assigned router of the client device, the BSSID(s) and signal strength patterns over various periods of time of a neighboring router(s), patterns in bandwidth availability over time of the neighboring router(s), the BSSIDs of neighboring routers to which the client device was previously connected, and so forth.

At step 810, the network connection manager determines the quiescent bandwidth (e.g., available bandwidth) of the selected neighboring router. In an embodiment, the available bandwidth may be determined based on the difference between the bandwidth capacity of the router and its typical bandwidth usage (e.g., the average bandwidth usage over a period of time).

At step 812, the network connection manager determines whether the available bandwidth of the neighboring router is sufficient to support the client device. In an embodiment the available bandwidth is sufficient if it allows for enough headroom for the client device to receive reserved bandwidth after serving other client devices already connected to the neighboring router. For example, the available bandwidth may be sufficient if it is greater than a bandwidth predetermined by the network connection manager, for instance, a minimum bandwidth, a default bandwidth, a bandwidth based on peak usage of the client device when served be its assigned router, and so forth. In another example, the available bandwidth is sufficient if it is greater than a bandwidth requested by the client device.

At step 814, if the neighboring router does not have sufficient available bandwidth to support the client device, the process terminates.

Otherwise, at step 816, if the neighboring router has sufficient available bandwidth to serve the client device, then the network connection manager dynamically configures a temporary connection for the client device to use the neighboring router while using the customer-specific SSID of the client device. The reserved bandwidth (or requested bandwidth) is then provisioned over the temporary connection. In an embodiment, the bandwidth may be provisioned over the backhaul connection using DOCSIS PCMM protocol (e.g., by way of a Dynamic Service Add (DSA) three-way handshake between the ISP cable modem and cable modem termination system). In an embodiment, the bandwidth may be allocated and provisioned over the wireless connection using, for example, weighted fair queuing.

In an embodiment, the connection terminates after a predetermined period of time. In another embodiment, the connection terminates when the client device leaves the location (e.g., there is a change in its location fingerprint in its location profile) or is otherwise no longer within a certain distance of the neighboring router (e.g., the neighboring router is no longer visible to the client device). In yet another embodiment, the connection terminates when the signal strength of the neighboring router drops below a certain level and/or the signal strength of the assigned router returns above a certain level. In an embodiment, the connection may be terminated by way of a PCMM Dynamic Service Delete (DSD) message. In an embodiment, the process 800 may be iterated between different client devices and neighboring routers.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying a first performance metric of a first wireless network connection between a client device and an access point, the first wireless network connection associated with a first BSSID, the first BSSID corresponding to the access point and a first location of the client device;
identifying a Service Set Identifier (SSID) associated with the client device and the first BSSID;
identifying a second BSSID detectable to the client device, the second BSSID corresponding to a second access point;
identifying a second performance metric of a second wireless network connection between the client device and the second access point, the second wireless network connection associated with the second BSSID;
determining that the second performance metric is better than the first performance metric; and
in response to the determining, configuring the second wireless network connection with the second BSSID and the SSID.

2. The method of claim 1, wherein the performance metric includes one or more of signal strength, bandwidth, retry rate, packet loss rate, latency, or jitter.

3. The method of claim 1, further comprising:
calculating an available bandwidth of the second access point;
determining that the second access point is capable of serving the client device based on the available bandwidth; and
in response to the determining that the second access point is capable of serving the client device, provisioning bandwidth to the client device over the second wireless network connection.

4. The method of claim 1, wherein the second wireless network connection is configured with the second BSSID and the SSID further in response to determining that a bandwidth of the access point is below a threshold.

5. The method of claim 1, wherein the client device is associated with a location profile, the location profile including at least one of a location fingerprint of the client device, signal strength data associated with at least one access point corresponding to a BSSID detectable to the client device at a previous location, or at least one BSSID corresponding to an access point previously connected to the client device at the previous location; and
wherein configuring the second wireless network connection with the second BSSID and the SSID is further based on:
determining a current location of the client device;
determining, based on the location profile, that the second access point corresponding to the second BSSID is at least one of: having a stronger signal strength of a plurality of access points at the current location, being frequently connected with the client device at the current location, or being recently connected with the client device at the current location.

6. The method of claim 1, further comprising:
in response to determining a change in a location fingerprint of the client device and determining that the first performance metric is better than the second performance metric at a current location of the client device:
reestablishing the first wireless network connection with the first BSSID and the SSID.

7. The method of claim 1, further comprising:
identifying a plurality of access points each having a performance metric below a threshold;
disabling the plurality of access points;
identifying an active access point corresponding to a BSSID detectable by each of the plurality of disabled access points;
configuring the active access point with a plurality of SSIDs, wherein each of the plurality of SSIDs is associated with one of the plurality of disabled access points; and
connecting client devices associated with each of the plurality of SSIDs with the active access point.

8. The method of claim 7, wherein each of the plurality of disabled access points periodically collects performance metric data of access points corresponding to BSSIDs detectable by the disabled access point.

9. The method of claim 3, wherein the second access point is configured to provision to the client device using PCMM protocol.

10. The method of claim 1, wherein a plurality of neighboring BSSIDs is detectable by the client device, and
wherein the second BSSID is further identified based on at least one of: determining that the second access point has a higher performance metric among access points corresponding to the plurality of neighboring BSSIDs; determining that the second access point is closer in distance to the client device among the access points corresponding to the plurality of neighboring BSSIDs; or determining that the second access point was recently connected with the client device.

11. The method of claim 1, further comprising:
directing LAN traffic between the first BSSID and the second BSSID to remain within a LAN boundary and from traversing a common switch device, wherein the LAN boundary comprises the first BSSID and the second BSSID, and wherein the common switch device is installed at a front-end of the first BSSID an the second BSSID.

12. The method of claim 1, wherein the SSID on the second wireless network connection is private.

13. A system comprising:
control circuitry configured to:
identify a first performance metric of a first wireless network connection between a client device and an access point, the first wireless network connection associated with a first BSSID, the first BSSID corresponding to the access point and a first location of the client device;
identify a Service Set Identifier (SSID) associated with the client device and the first BSSID;
identify a second BSSID detectable to the client device, the second BSSID corresponding to a second access point;
identify a second performance metric of a second wireless network connection between the client device and the second access point, the second wireless network connection associated with the second BSSID;
determine that the second performance metric is better than the first performance metric; and
in response to the determining, configure the second wireless network connection with the second BSSID and the SSID.

14. The system of claim 13, wherein the performance metric includes one or more of signal strength, bandwidth, retry rate, packet loss rate, latency, or jitter.

15. The system of claim 13, wherein the control circuitry is further configured to:
calculate an available bandwidth of the second access point;
determine that the second access point is capable of serving the client device based on the available bandwidth; and
in response to determining that the second access point is capable of serving the client device, provision bandwidth to the client device over the second wireless network connection.

16. The system of claim 13, wherein the second wireless network connection is configured with the second BSSID and the SSID further in response to determining that a bandwidth of the access point is below a threshold.

17. The system of claim 13, wherein the client device is associated with a location profile, the location profile including at least one of a location fingerprint of the client device, signal strength data associated with at least one access point corresponding to a BSSID detectable to the client device at a previous location, or at least one BSSID corresponding to an access point previously connected to the client device at the previous location; and
wherein configuring the second wireless network connection with the second BSSID and the SSID is further based on:
determining a current location of the client device;
determining, based on the location profile, that the second access point corresponding to the second BSSID is at least one of: having a stronger signal strength of a plurality of access points at the current location, being frequently connected with the client device at the current location, or being recently connected with the client device at the current location.

18. The system of claim 13, wherein the control circuitry is further configured to:
in response to determining a change in a location fingerprint of the client device and determining that the first performance metric is better than the second performance metric at a current location of the client device:
reestablish the first wireless network connection with the first BSSID and the SSID.

19. The system of claim 13, wherein the control circuitry is further configured to:
identify a plurality of access points each having a performance metric below a threshold;
disable the plurality of access points;
identify an active access point corresponding to a BSSID detectable by each of the plurality of disabled access points;
configure the active access point with a plurality of SSIDs, wherein each of the plurality of SSIDs is associated with one of the plurality of disabled access points; and
connect client devices associated with each of the plurality of SSIDs with the active access point.

20. The system of claim 19, wherein each of the plurality of disabled access points periodically collects performance metric data of access points corresponding to BSSIDs detectable by the disabled access point.

21-36. (canceled)
